(19) United States
(12) Patent Application Publication
(10) Pub. No.: US 2024/0013483 A1
(43) Pub. Date: Jan. 11, 2024

(54) Enabling Multiple Virtual Reality Participants to See Each Other

(71) Applicant: Kenneth Perlin, New York, NY (US)

(72) Inventor: Kenneth Perlin, New York, NY (US)

(21) Appl. No.: 18/371,390

(22) Filed: Sep. 21, 2023

Related U.S. Application Data
(63) Continuation-in-part of application No. 17/666,364, filed on Feb. 7, 2022.
(60) Provisional application No. 63/409,347, filed on Sep. 23, 2022.

(51) Int. Cl. G06T 17/00; G06T 5/50; G06F 3/01; H04N 13/351; G02B 27/01

(52) U.S. Cl. CPC G06T 17/00; G06T 5/50; G06F 3/012; H04N 13/351; G02B 27/0172; G06T 2207/20221

(57) ABSTRACT

A system for viewing in a structure having a first participant and at least a second participant each having a VR headset to be worn by the first and second participants. The system has a first computer hard wired to the first VR headset. Each participant sees every other participant in the structure as every other participant physically appears in the structure in real time in a simulated world simultaneously displayed about them by the respective VR headset each participant is wearing. Each participant sees the simulated world from their own correct perspective in the structure. The system has coloring on at least a portion of the structure so the portion of the structure with coloring does not appear in the simulated world. Method for viewing in a structure having a first participant and at least a second participant.

### CROSS-REFERENCE TO RELATED APPLICATIONS

This is a non-provisional patent application of U.S. provisional patent application Ser. No. 63/409,347 filed Sept. 23, 2022, and is a continuation-in-part of U.S. patent application Ser. No. 17/666,364, all of which are incorporated by reference herein.

### FIELD OF THE INVENTION

The present invention is related to participants in a structure viewing a shared virtual reality experience while also seeing each other. More specifically, the present invention is related to participants in a structure viewing a shared virtual reality experience while also seeing each other where each participant has a virtual reality headset with a camera.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

When people watch a movie together in a movie theater, they cannot experience the degree of visual immersion that they can experience when attending a live theater performance or viewing a virtual reality (VR) experience. Unlike either a live theater performance or a VR experience, the image on a movie screen does not change in response to translational movement of a participant's head, even if that movie is a 3D movie. But unlike a VR experience, participants watching a movie together in a movie theater have the benefit of being able to see each other.

The current invention combines an important benefit of a traditional movie in a movie theater—providing participants with the ability to see each other—with an important benefit of a VR experience—a compelling sense of visual immersion for each participant, with a point of view into a shared virtual scene that changes correctly in response to translational movement of that participant's head.

### BRIEF SUMMARY OF THE INVENTION

The present invention pertains to a system for viewing in a structure having a first participant and at least a second participant. The system comprises a first VR headset to be worn by the first participant. The first VR headset having an inertial motion unit, and at least a first camera. The system comprises a first computer. The system comprises a first hard wired connection 4a between the first computer and the first VR headset. The system comprises a second VR headset to be worn by the second participant. The second VR headset having an inertial motion unit, and at least a second camera. Each participant sees every other participant in the structure as every other participant physically appears in the structure in real time in a simulated world simultaneously displayed about them by the respective VR headset each participant is wearing. Each participant sees the simulated world from their own correct perspective in the structure. The system comprises a network interface. The system comprises a network connection between the first computer and the network interface. The system comprises a marker attached to the structure for the first and second VR headsets to determine locations of the first and second participants wearing the first and second VR headsets, respectively, in the structure and their own correct perspective in the structure. The system comprises coloring on at least a portion of the structure so the portion of the structure with coloring does not appear in the simulated world.

The present invention pertains to a method for viewing in a structure having a first participant and at least a second participant. The method comprises the steps of sending from a first VR headset on a first participant via a first wired connection to a first computer, associated with the first participant, position and orientation of the first VR headset. There is the step of sending from a second VR headset on a second participant via a second wired connection to a second computer, associated with the second participant, position and orientation of the second VR headset. There is the step of sending left/right image pairs from a first stereo color camera of the first VR headset via the first wired connection to the first computer. There is the step of sending left/right image pairs from a second stereo color camera of the second VR headset via the second wired connection to the first computer. There is the step of compositing by the first computer the left/right image pairs from the first stereo color camera over a rendered virtual reality scene wherever pixels of the left/right image pairs from the first stereo color camera are a predesignated color to create first resulting composite images. There is the step of compositing by the second computer the left/right image pairs from the second stereo color camera over the rendered virtual reality scene wherever pixels of the left/right image pairs from the second stereo color camera are the predesignated color to create second resulting composite images. There is the step of sending from the first computer to the first VR headset the first resulting composite images via the first wired connection to be displayed in the first VR headset. There is the step of sending from the second computer to the second VR headset the second resulting composite images via the second wired connection to be displayed in the second VR headset.

The present invention pertains to a method for viewing in a structure having a first participant and at least a second participant. The method comprises the steps of streaming view—independent scene data to each computer of a plurality of computers of the first and second participants. There is the step of determining by each VR headset of a plurality of headsets each VR headset's own position and orientation via inside—out tracking. There is the step of sending position and orientation of each VR headset via a wired data connection to each participants computer. There is the step of each computer using the position and orientation and view independent scene data to render left and right eye views of a virtual scene. There is the step of sending via the wired connection to the computer of each participant, left/right image pairs from a stereo color camera of each VR headset of each participant. There is the step of each computer compositing the left/right image pairs over a rendered scene forever camera pixels are green. There is the step of sending resulting composite images from each computer to each associated VR headset via the wired data connection to be displayed in the associated VR headset.

### BRIEF DESCRIPTION OF THE DRAWINGS

FIG. 1 shows components of the present invention.

FIG. 2 shows participants sitting in rows seeing the other participants, while they all share a consistent VR experience.

FIG. 3 shows participants arranged at multiple tables, while they all share a consistent VR experience.

FIG. 4 shows the step-by-step internal operation of the claimed invention.

### DETAILED DESCRIPTION OF THE INVENTION

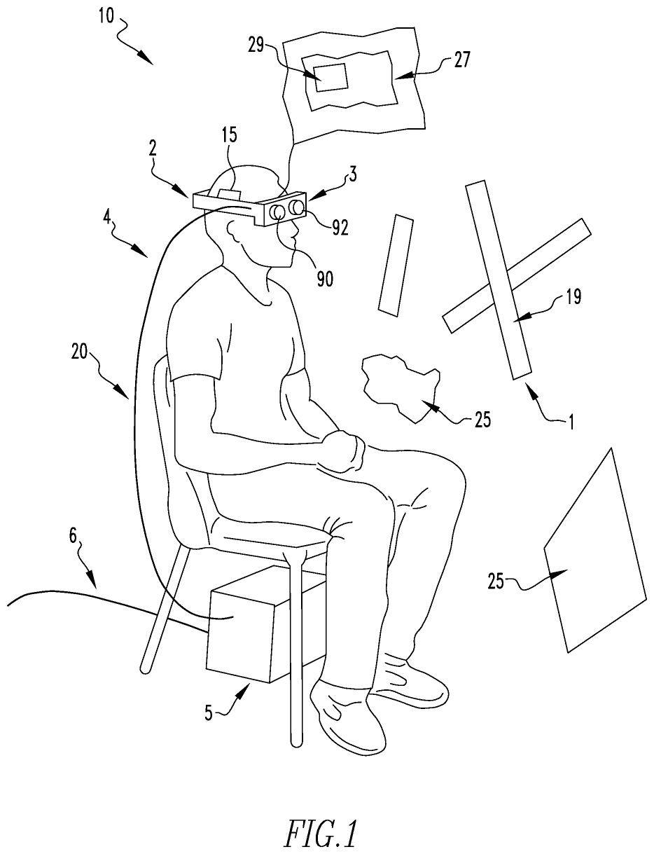

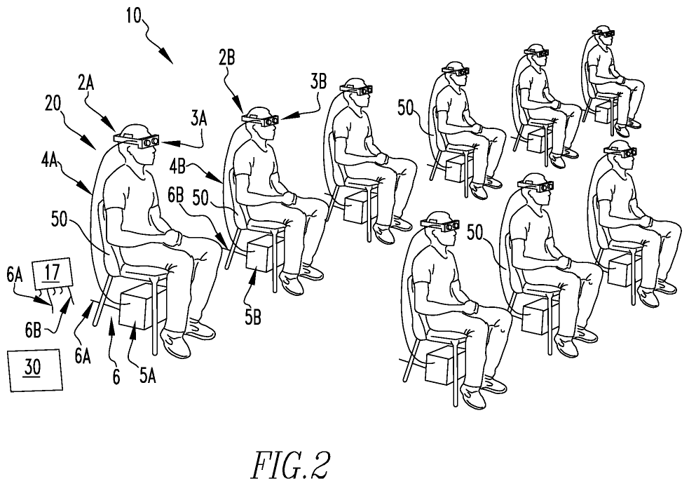

Referring now to the drawings wherein like reference numerals refer to similar or identical parts throughout the several views, and more specifically to FIGS. 1 and 2 thereof, there is shown a system 10 for viewing in a structure 1 having a first participant 20 and at least a second participant 22. The system 10 comprises a first VR headset 2a to be worn by the first participant 20. The first VR headset 2a having an inertial motion unit 15, and at least a first camera 3a. The system 10 comprises a first computer 5a. The system 10 comprises a first hard wired connection 4a between the first computer 5a and the first VR headset 2a. The system 10 comprises a second VR headset 2b to be worn by the second participant 22. The second VR headset 2b having an inertial motion unit 15, and at least a second camera 3b. Each participant sees every other participant in the structure 1 as every other participant physically appears in the structure 1 in real time in a simulated world 27 simultaneously displayed about them by the respective VR headset each participant is wearing. Each participant sees the simulated world 27 from their own correct perspective in the structure 1. The system 10 comprises a network interface 17. The system 10 comprises a network connection 6 between the first computer 5a and the network interface 17. The system 10 comprises a marker 19 attached to the structure 1 for the first and second VR headsets 2a, 2b to determine locations of the first and second participants 20, 22 wearing the first and second VR headsets, respectively, in the structure 1 and their own correct perspective in the structure 1. The system 10 comprises coloring 25 on at least a portion of the structure 1 so the portion of the structure 1 with coloring 25 does not appear in the simulated world 27. The coloring 25 may be green and green screening is applied in regard to see or not see actual physical objects in the structure 1 in the simulated world 27 viewed by the participants in the VR headsets 2 they are wearing.

The system 10 may include a second computer 5b and a second hard wired connection 4b between the second computer 5b and the second VR headset 2b. The network connection 6 may include a third hard wired connection 6a between the first computer 5a and the network interface 17 and a fourth hard wired connection 6b between the second computer 5b and the network interface 17.

The simulated world 27 may include content 29, in a form of time varying view-independent three-dimensional scene data. The content 29 may be either pre-stored on each of the first and second computers 5a, 5b, or, alternatively, simultaneously streamed to each of the first and second computers 5a, 5b from a server 30 via the third and fourth wired connections or, alternatively, simultaneously broadcast from the server 30 to the first and second computers 5a, 5b via a wireless network.

The inertial motion unit 15 in the first and second VR headsets 2a, 2b may be used to estimate a rotation of the first and second participant's head, respectively, in both yaw and pitch from a moment in time when a stereo image pair is captured by the first and second cameras 3a, 3b, respectively, to a later moment in time when a final composited scene is displayed on the first and second VR headsets 2a, 2b, respectively. The rotation is used to perform a two dimensional image shift—specifically, a horizontal shift based on a change in head yaw and a vertical shift based on a change in head pitch—on both left and right camera images 40, 42 of the first and second cameras 3a, 3b before the left and right camera images 40, 42 of the first and second cameras 3a, 3b are composited with the simulated world 27, so that other participants and non-green objects in the structure 1 appear in a correct direction with respect to the observing participant in a final composited and displayed VR stereo image in the simulated world 27 of the observing participant.

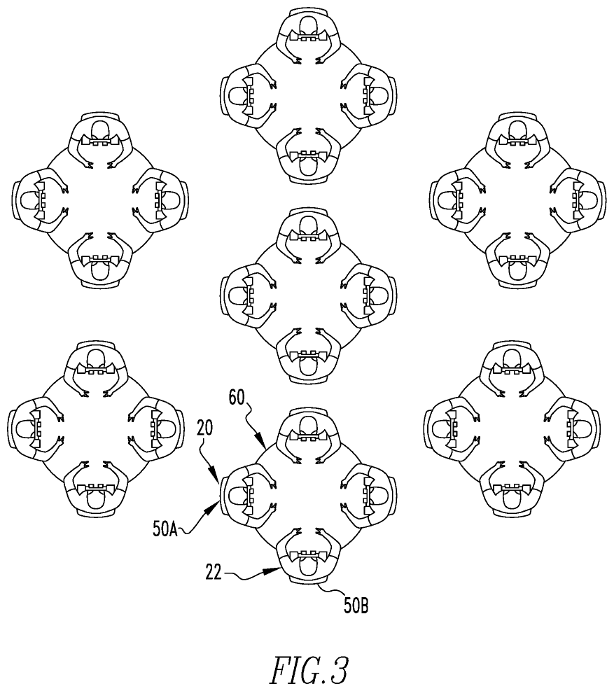

The system 10 may include rows of chairs 50 and the first and second participants 20, 22 are each positioned to sit in one of the chairs 50 so the first and second participants 20, 22 see each other and share a consistent VR experience. See FIG. 2. The system 10 may include at least a first table 60 and a first chair 50a and a second chair 50b positioned about the first table 60 and the first and second participants 20, 22 sit at the first and second chairs 50a, 50b, respectively, about the first table 60 and share a consistent VR experience. See FIG. 3.

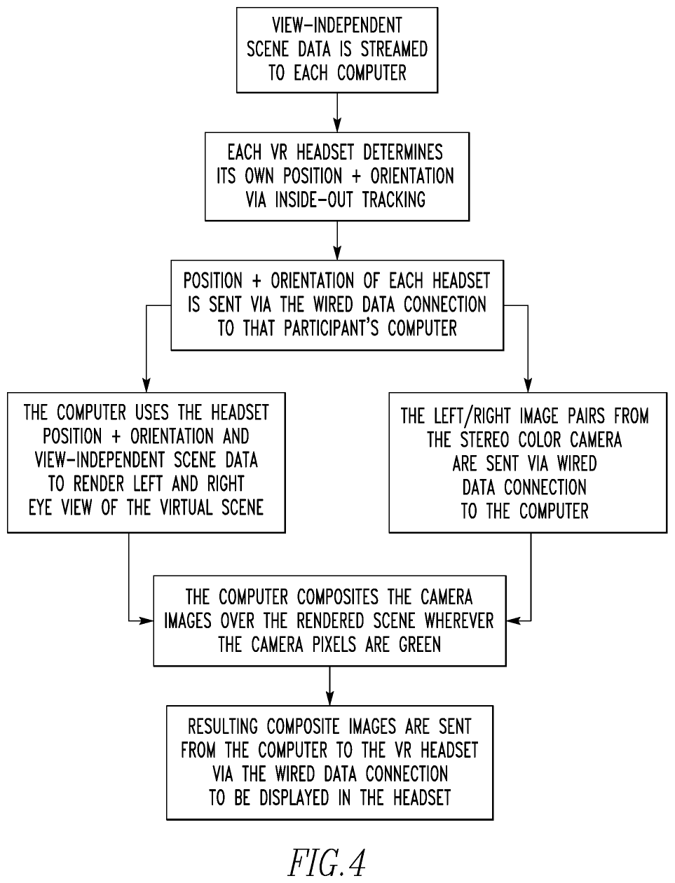

The present invention pertains to a method for viewing in a structure 1 having a first participant 20 and at least a second participant 22. See FIG. 4. The method comprises the steps of sending from a first VR headset 2a on a first participant 20 via a first wired connection to a first computer 5a, associated with the first participant 20, position and orientation of the first VR headset 2a. There is the step of sending from a second VR headset 2b on a second participant 22 via a second wired connection to a second computer 5b, associated with the second participant 22, position and orientation of the second VR headset 2b. There is the step of sending left/right image pairs from a first stereo color camera of the first VR headset 2a via the first wired connection to the first computer 5a. There is the step of sending left/right image pairs from a second stereo color camera of the second VR headset 2b via the second wired connection to the first computer 5a. There is the step of compositing by the first computer 5a the left/right image pairs from the first stereo color camera over a rendered virtual reality scene wherever pixels of the left/right image pairs from the first stereo color camera are a predesignated color to create first resulting composite images. There is the step of compositing by the second computer 5b the left/right image pairs from the second stereo color camera over the rendered virtual reality scene wherever pixels of the left/right image pairs from the second stereo color camera are the predesignated color to create second resulting composite images. There is the step of sending from the first computer 5a to the first VR headset 2a the first resulting composite images via the first wired connection to be displayed in the first VR headset 2a. There is the step of sending from the second computer 5b to the second VR headset 2b the second resulting composite images via the second wired connection to be displayed in the second VR headset 2b.

There may be the step of the first computer 5a using the first VR headset 2a position and orientation and view—independent scene data to render left and right eye views of the virtual scene for the first VR headset 2a, and the second computer 5b using the second VR headset 2b position and orientation and view—independent scene data to render left and right eye views of the virtual scene for the second VR headset 2b. There may be the step of streaming view—independent scene data to the first computer 5a and the second computer 5b. There may be the step of the first VR headset 2a determining the first VR headset's own position and orientation via inside—out tracking, and the second VR headset 2b determining the second VR headset's own position and orientation via inside—out tracking.

The present invention pertains to a method for viewing in a structure 1 having a first participant 20 and at least a second participant 22. The method comprises the steps of streaming view—independent scene data to each computer of a plurality of computers of the first and second participants 20, 22. There is the step of determining by each VR headset of a plurality of headsets each VR headset's own position and orientation via inside—out tracking. There is the step of sending position and orientation of each VR headset via a wired data connection to each participants computer. There is the step of each computer using the position and orientation and view independent scene data to render left and right eye views of a virtual scene. There is the step of sending via the wired connection to the computer of each participant, left/right image pairs from a stereo color camera of each VR headset of each participant. There is the step of each computer compositing the left/right image pairs over a rendered scene forever camera pixels are green. There is the step of sending resulting composite images from each computer to each associated VR headset via the wired data connection to be displayed in the associated VR headset.

### User Experience

Participants are located within the same physical room. The position of each participant within the room is flexible. For example, participants can sit in rows of chairs 50 (FIG. 2), or recline on couches, or sit or stand around tables so that participants face each other (FIG. 3).

Each participant is assigned a VR headset, which is connected via a wired data connection to a computer. All participants put on their headset at the outset of the viewing experience. After putting on their headsets, participants continue to be able to see each other, and are also optionally able to continue seeing selected physical objects and furniture in the room.

The viewing experience that surrounds each participant appears to that participant to be fully three dimensional. In particular, in response to translational movement of the participant's head, the perspective views seen by their left and their right eye, respectively, shift so as to continually provide the correct view for each eye, as would be the case in a live theater performance.

The key innovation is to enable the combination of (1) enabling participants to see one another (and optionally also selected physical objects and furniture in the room) while (2) immersing all participants in a fully dimensional shared virtual world. The novel technology disclosed herein enables this shared experience to be experienced simultaneously in the same room by as many participants as is desired, with no practical limitation on the number of participants.

FIG. 2 shows the participants sitting in rows can see the other participants, while they all share a consistent VR experience. FIG. 3 shows participants can optionally be arranged at multiple tables. This enables many choices as to how to present the virtual content 29. In one scenario, participants at all tables share the same virtual world. In another scenario, participants at each table can see participants at the other tables, but they share a virtual world with only the other participants at their own table. If the table surface is colored green, then the table surface can be part of the shared virtual world for participants at that table. FIG. 4 shows the Step-by-step operation of the invention.

Content 29, in the form of time varying view-independent three-dimensional scene data, can be either pre-stored on each computer or, alternatively, simultaneously streamed to each computer from a Cloud server 30 via a wired network (6) or, alternatively, simultaneously broadcast to all computers via a wireless network.

In this way, for example, all participants in the room can simultaneously experience the same immersive VR movie or other time-varying experience. Each participant will be able to experience the time-varying virtual scene as seen from their own unique position and orientation within the room.

Each VR headset (2) determines its own position and orientation via inside-out tracking techniques that are standard in the art, based on the variations in brightness in the surfaces of the patterned green screen room (1). Surfaces of the room, which can include walls, floor, ceiling, doors and furniture, are green in color, with some regions being lighter green and other regions being darker green. As is standard in the art, a gray-scale inside-out tracking camera within the VR headset perceives the difference in brightness at boundaries between the lighter and darker green areas of the room surfaces, and uses those differences to perform a standard inside-out position+orientation tracking computation.

The position+orientation information from each participant's VR headset (2) is then sent via the wired data connection (3) to the computer associated with that participant (4). The position of the computer itself is flexible. The computer can, for example, be mounted on the user's head or torso, or carried in the user's hand, or located underneath or behind the user's seat, or else reside within a rack of computers in an adjoining room or in a different building.

At each successive animation frame, the computer uses the position+orientation information from the VR headset, together with the view-independent scene data, to render both the left eye and the right eye views of the virtual scene, as is standard in the art.

Meanwhile, successive left/right image pairs from the forward-facing stereo color camera pair mounted on the front of the VR headset (3) are sent via the wired data connection (4) to the computer (5).

The computer then examines each pixel in each of the left and right images from the color stereo camera pair to determine whether that pixel is green. A green pixel indicates to the computer that the camera is viewing a green surface of the room at that pixel, rather than viewing another participant or a non-green object in the room.

For pixels in the left camera image that are not green, the computer replaces the corresponding pixel in the left eye view of the virtual scene by the color of that pixel from the left camera image. Similarly, for pixels in the right camera image that are not green, the computer replaces the corresponding pixel in the right eye view of the virtual scene by the color of that pixel from the right camera image.

The now modified left and right images are then sent back from the computer to the VR headset, via the wired data connection between the computer and the VR headset, to be displayed to the participant who is wearing that VR headset.

By this means, each participant sees the shared virtual world in all places where the surrounding green room is visible to that participant, and sees other participants, or any physical objects or furniture that are not colored green, in all places where the presence of those other participants or non-green objects blocks the participant's view of the surrounding green room.

Note in particular that the described method uses the patterned green surfaces of the room in two distinct and complementary ways: (a) The variation in brightness, independent of color, is used only to support the inside-out positioned+orientation tracking of each VR headset; (b) The green color, independent of brightness, is used only to support compositing other participants and any non-green objects within the room into the virtual reality scene.

Latency in the communication between the VR headset and the computer can lead to a perceptible time lag in each participant's view of the other participants and non-green objects in the room. To reduce such latency, an alternate implementation of the green screen compositing method is to send the color stereo camera data not to the computer, but rather to the VR headset itself. The processor in the VR headset then performs the green screen compositing operation between the 3D scene that is simulated on the computer and the image pair coming from the stereo camera. This compositing computation can be performed by the graphics processing unit (GPU) in the VR headset, using the left and right stereo camera images as digital texture sources in the GPU rendering computation on the VR headset.

Wherever the compositing computation is performed, the inertial motion unit 15 (IMU) in the VR headset is used to estimate the rotation of the participant's head in both yaw and pitch from the moment in time when the stereo image pair is captured by the camera to the later moment in time when the final composited scene will be displayed on the VR headset. This rotation is used to perform a two dimensional image shift—specifically, a horizontal shift based on the change in head yaw and a vertical shift based on the change in head pitch—on both the left and right camera images 40, 42 before they are composited with the virtual scene, in a manner that is standard in the art, so that the other participants and non-green objects in the room will appear in the correct direction with respect to the observing participant in the final composited and displayed VR stereo image, even though end-to-end latency causes those other participants and non-green objects to be displayed as they appeared slightly in the past.

An interesting special case occurs when the streamed content 29 is a 360° movie. In this case, the computer assigned to each VR headset does not need to be as powerful, because it only needs to select a partial angular view, based on the direction that the participant is currently facing, from the 360° movie that is streaming in from the Cloud server 30. This allows the use of an inexpensive computer for each participant, which can be very advantageous for a venue that supports a large number of simultaneous participants. In this special case, as in the more general case already described, each participant is able to see the other people in the room, as well as any non-green objects in the room, while viewing the shared immersive content 29 in their VR headset. Note that even though, in this special case, the streamed content 29 itself does not change in response to translational movement of the participant's head, the participant's view of other people and non-green objects in the room does indeed change properly in response to translational movement of the participant's head. This can be particularly compelling in those cases where the content 29 is meant to convey the sense that participants are looking out upon a large vista. One example is as follows: The non-green objects and furniture in the room are designed to look like a spaceship, and the story being told is that participants are going on an interplanetary voyage together. In this case the shared virtual content 29—the “view out of the window”—is of distant planets and stars.

The above-described capabilities can be combined with physical effects which are standard in the art that help to create a compelling experience of physical immersion for each participant. For example, each participant's seat can be made to vibrate or can tilt in a way that simulates forces felt during linear acceleration. The back of each chair can also recline, either under manual control by the participant or under computer control. Also, air flow through the room can simulate wind to suggest linear velocity. In one embodiment, air is introduced into the room by means of ducts that transmit air from one or more fans. These ducts can remain invisible to the participants by being colored green and therefore visually blending into the virtual world.

The present invention enables an unlimited number of participants within the same room to experience and share virtual reality while also being able to see each other and any non-green objects.

This is similar to U.S. patent application Ser. No. 17/666,364, incorporated by reference herein, in that (1) a patterned green screen room is combined with (2) inside-out tracked VR headsets upon which are mounted forward-facing color stereo camera pairs, and that combination is being used to simultaneously perform (a) inside-out tracking (which depends only on room brightness) and (b) foreground/background matting (which depends only on room color).

In the present invention, the focus is for each participant to sit down and have a wired connection to a computer that can be capable of computing powerful real-time graphics, and also that (2) view-independent data can be streaming simultaneously from a Cloud server 30 to every participant's computer.

Also, the view-independent data streaming from the Cloud server 30 to each computer can be implemented either via a wired connection or via simultaneous wireless broadcast to each computer.

Here are some benefits from explicitly specifying a wired connection to a powerful computer, rather than focusing on a computer that needs to be incorporated into the VR headset itself:
1: This version of the invention can support far greater graphics capability than one in which every VR headset is wireless. In practice, a computer that can be plugged into a wall outlet can be about 100 times more powerful than a battery powered computer that fits into a VR headset.
2: Providing each participant with such a powerful computer makes it far more useful to stream the same view-independent scene from a Cloud server 30 to every participant's computer, since a powerful graphics computer can make far better use of that view-independent scene data to render compelling and realistic scenes than could be achieved by the much less powerful battery powered computer that could be supported entirely within the VR headset itself.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A system for viewing in a structure having a first participant and at least a second participant comprising:
a first VR headset to be worn by the first participant, the first VR headset having an inertial motion unit, and at least a first camera;
a first computer;
a first hard-wired connection between the first computer and the first VR headset;
a second VR headset to be worn by the second participant, the second VR headset having an inertial motion unit, and at least a second camera, each participant sees every other participant in the structure as every other participant physically appears in the structure in real time in a simulated world simultaneously displayed about them by the respective VR headset each participant is wearing, each participant sees the simulated world from their own correct perspective in the structure;
a network interface;
a network connection between the first computer and the network interface;
a marker attached to the structure for the first and second VR headsets to determine locations of the first and second participants wearing the first and second VR headsets, respectively, in the structure and their own correct perspective in the structure; and
coloring on at least a portion of the structure so the portion of the structure with coloring does not appear in the simulated world.

2. The system of claim 1 including a second computer and a second hard wired connection between the second computer and the second VR headset.

3. The system of claim 2 wherein the network connection includes a third hard wired connection between the first computer and the network interface and a fourth hard wired connection between the second computer and the network interface.

4. The system of claim 3 wherein the simulated world includes content, in a form of time varying view-independent three-dimensional scene data.

5. The system of claim 4 wherein the content is either pre-stored on each of the first and second computers or, alternatively, simultaneously streamed to each of the first and second computers from a server via the third and fourth wired connections or, alternatively, simultaneously broadcast from the server to the first and second computers via a wireless network.

6. The system of claim 5 wherein the inertial motion unit in the first and second VR headsets is used to estimate a rotation of the first and second participant's head, respectively, in both yaw and pitch from a moment in time when a stereo image pair is captured by the first and second cameras, respectively, to a later moment in time when a final composited scene is displayed on the first and second VR headsets, respectively, the rotation is used to perform a two dimensional image shift—specifically, a horizontal shift based on a change in head yaw and a vertical shift based on a change in head pitch—on both left and right camera images of the first and second cameras before the left and right camera images of the first and second cameras are composited with the simulated world, so that other participants and non-green objects in the structure appear in a correct direction with respect to the observing participant in a final composited and displayed VR stereo image in the simulated world of the observing participant.

7. The system of claim 6 including rows of chairs and the first and second participants are each positioned to sit in one of the chairs so the first and second participants see each other and share a consistent VR experience.

8. The system of claim 6 including at least a first table and a first chair and a second chair positioned about the first table and the first and second participants sit at the first and second chairs, respectively, about the first table and share a consistent VR experience.

9. A method for viewing in a structure having a first participant and at least a second participant comprising the steps of:
sending from a first VR headset on a first participant via a first wired connection to a first computer, associated with the first participant, position and orientation of the first VR headset;
sending from a second VR headset on a second participant via a second wired connection to a second computer, associated with the second participant, position and orientation of the second VR headset;
sending left/right image pairs from a first stereo color camera of the first VR headset via the first wired connection to the first computer;
sending left/right image pairs from a second stereo color camera of the second VR headset via the second wired connection to the first computer;
compositing by the first computer the left/right image pairs from the first stereo color camera over a rendered virtual reality scene wherever pixels of the left/right image pairs from the first stereo color camera are a predesignated color to create first resulting composite images;
compositing by the second computer the left/right image pairs from the second stereo color camera over the rendered virtual reality scene wherever pixels of the left/right image pairs from the second stereo color camera are the predesignated color to create second resulting composite images;
sending from the first computer to the first VR headset the first resulting composite images via the first wired connection to be displayed in the first VR headset; and
sending from the second computer to the second VR headset the second resulting composite images via the second wired connection to be displayed in the second VR headset.

10. The method of claim 9 including the step of the first computer using the first VR headset position and orientation and view—independent scene data to render left and right eye views of the virtual scene for the first VR headset, and the second computer using the second VR headset position and orientation and view—independent scene data to render left and right eye views of the virtual scene for the second VR headset.

11. The method of claim 10 including the step of streaming view—independent scene data to the first computer and the second computer.

12. The method of claim 11 including the step of the first VR headset determining the first VR headset's own position and orientation via inside—out tracking, and the second VR headset determining the second VR headset's own position and orientation via inside—out tracking.

13. A method for viewing in a structure having a first participant and at least a second participant comprising the steps of:
streaming view—independent scene data to each computer of a plurality of computers of the first and second participants;
determining by each VR headset of a plurality of headsets each VR headset's own position and orientation via inside—out tracking;
sending position and orientation of each VR headset via a wired data connection to each participants computer;
each computer using the position and orientation and view independent scene data to render left and right eye views of a virtual scene;
sending via the wired connection to the computer of each participant, left/right image pairs from a stereo color camera of each VR headset of each participant;
each computer compositing the left/right image pairs over a rendered scene forever camera pixels are green; and
sending resulting composite images from each computer to each associated VR headset via the wired data connection to be displayed in the associated VR headset.
